(19) United States
(12) Patent Application Publication
(10) Pub. No.: US 2009/0293002 A1
(43) Pub. Date: Nov. 26, 2009

(54) Method for generating a set user identifiers associated with user introduction information, method for accessing this information, associated server and terminal

(75) Inventor: Pascal LE GOFF, Brest (FR)

Correspondence Address: FAY SHARPE/LUCENT, 1228 Euclid Avenue, 5th Floor, The Halle Building, Cleveland, OH, 44115-1843, US

(73) Assignee: Alcatel Lucent, Paris (FR)

(21) Appl. No.: 12/408,293

(22) Filed: Mar. 20, 2009

(30) Foreign Application Priority Data
Mar. 20, 2008 (FR) FR 0801522

(51) Int. Cl. G06F 3/00; G06F 15/16; H04N 7/14; H04M 3/42

(52) U.S. Cl. 715/753; 348/14.08; 379/202.01; 709/204

(57) ABSTRACT

The invention pertains to a method for generating a set (13) of user (7) identifiers (11) associated with a communication terminal's (3, 3′) user's (7) introduction information (9) transmitted during a communication session established between said terminals (3, 3′) by means of a telecommunication network (1), comprising the following steps:
users' (7) introduction information (9) transmitted by at least one of said terminals (3, 3) during the communication session established between said terminals (3, 3) is received;
said introduction information is recorded (9);
a user identifier (11) is associated with said saved introduction information (9),
a set (13) of user identifiers (11) is sent in such a way that a user (7, 7′) of a communication terminal (3, 3′) can select a user identifier (11) from among said set (13) and thereby be able to access said introduction information (9) associated with the selected user identifier (11).

The invention further pertains to a method enabling at least one user (7, 7′) of a communication terminal (3, 3′) to access this user's (7, 7′) introduction information (9).

The invention further pertains to a communication session server (5) and a communication terminal (3, 3′) for implementing such methods.

This application is based on and claims the benefit of French Patent Application n^{o} 0801522 filed on Mar. 20, 2008, which is incorporated by reference herein in its entirety.

### TECHNICAL FIELD

The invention pertains to a method for generating a set of user identifiers associated with communication terminal users' introduction information transmitted during a communication session established between said terminals by means of a telecommunication network.

The invention further pertains to a method enabling at least one communication terminal user to access user introduction information based on associated user identifiers.

The invention further pertains to a communication server and a communication terminal for implementing such methods.

### BACKGROUND

The purpose of a communication session is to enable communication, such as a meeting, between participants located at sites which are generally remote, by means of a telecommunication network.

The term “telecommunication network” refers to any sort of fixed or mobile telecommunication network (for example a GSM, GPRS, UMTS, or WiFi network, or an Internet network, or a wired network), which transmits data, such as in the form of flows intended for communication terminals capable of receiving the transmitted data. The telecommunication network may be capable of exchanging data, messages, or requests with these same terminals.

Any data transmission mode may be considered, and particularly multi-peer (or “multicast”) mode, i.e. one making it possible to establish a communication session between participants from several sites, but also peer-to-peer (or “unicast”) mode, i.e. one making it possible to establish a communication session between participants from two sites.

Furthermore, the term “communication terminal” refers to any type of equipment capable of exchanging data, messages, and requests with a telecommunication network of the aforementioned type, and capable of establishing a communication flow with another terminal.

It may, for example, be a land-line or mobile telephone, a desktop or portable computer, a personal digital assistant (or PDA), or videoconferencing equipment, or a device capable of receiving audio and/or video data.

However, if a communication session has already been established between communication terminals and a participant joins the already-begun communication session, this participant does not have every participant's introduction information, which were exchanged at the beginning of the communication session, for example.

In such circumstances, a participant who arrives at a session that is underway may end up interrupting the proceedings of the communication session in order to get this missing information, by asking the other participants.

### SUMMARY

The purpose of the invention is therefore to overcome this drawback by disclosing a method for generating a set of user identifiers associated with communication terminal users' introduction information transmitted during a communication session established between said terminals by means of a telecommunication network, comprising the following steps:
user introduction information, transmitted by at least one of said terminals during the communication session established between said terminals, is received;
said introduction information is saved;
a user identifier is associated with said saved introduction information;
a set of user identifiers is sent in such a way that a communication terminal's user can select a user identifier from among this set, and thereby have access to said introduction information associated with the selected user identifier.

In one particular embodiment, the communication session is a telephone conference.

In one preferential embodiment, the communication session is a videoconference.

Preferably, the information is recorded in the form of electronic calling cards.

In one advantageous embodiment, the introduction information includes audio data.

In one preferred embodiment, the introduction information includes video data.

The invention further discloses a method enabling at least one user of a communication terminal to access communication terminal users' introduction information transmitted during a communication session established between said terminals by means of a telecommunication network, based on associated user identifiers, comprising the following steps:
selecting at least one user identifier from a set of user identifiers;
sending a request for user introduction information associated with the selected user identifier;
receiving the user introduction information associated with the selected user identifier; and
delivering the information to the user in a visible and/or audible form.

The invention further discloses a server enabling communication sessions between communication terminals by means of a telecommunication network, comprising at least one processing means for:
receiving user introduction information transmitted by at least one of said terminals,
saving said introduction information,
associating a user identifier with said saved introduction information, and
sending a set of user identifiers over said network.

Preferentially, the server comprises at least one processing means for:
receiving a request for a user's introduction information,
processing said request, and
transmitting said user's introduction information over said network.

The invention further discloses a communication terminal capable of establishing a communication session with at least one other communication terminal by means of a telecommunication network, comprising at least one processing means for:
transmitting said terminal's user's introduction information over said network; and
receiving a set of user identifiers respectively associated with introduction information for the users of said terminals.

Advantageously, the terminal comprises at least one processing means for:
selecting a user identifier from among said set;
sending a request for said user's introduction information;
receiving said introduction information associated with the selected user identifier; and
delivering said received introduction information in a visible and/or audible form.

### BRIEF DESCRIPTION OF THE DRAWINGS

Other characteristics and advantages of the invention will become apparent upon reading the following description, given as an example, with reference to the attached drawings, in which:

FIG. 1 schematically depicts the general structure of a system for implementing the inventive methods;

FIG. 2 depicts an example of data displayed on a terminal during the steps of an inventive method for accessing user introduction information;

FIG. 3a depicts the successive steps of an inventive method for generating a set of user identifiers associated with user introduction information, and

FIG. 3b depicts the successive steps of an inventive method for accessing user introduction information.

### DESCRIPTION OF EMBODIMENTS

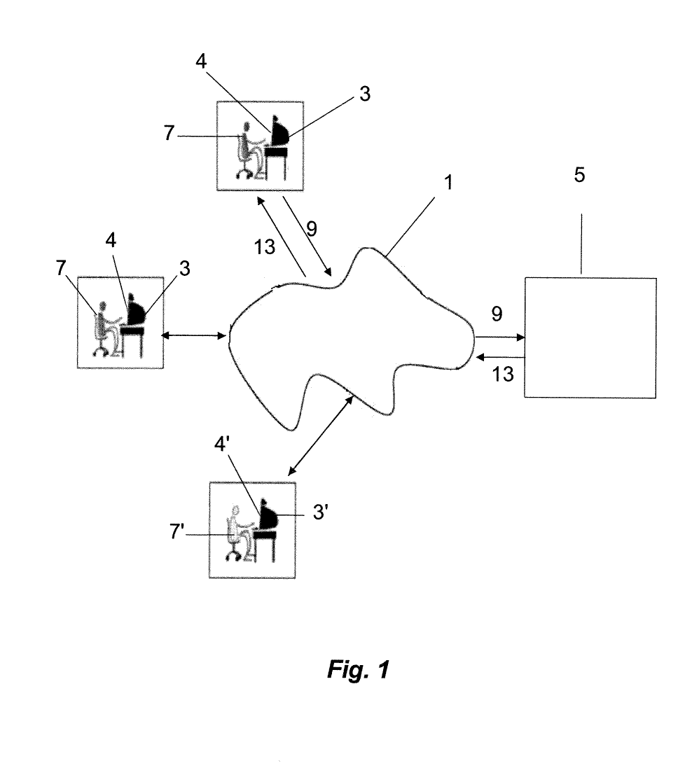

FIG. 1 shows a fixed or mobile telecommunication network 1 (for example, a GSM, GPRS, UMTS, or WiFi network, or an Internet network, or a wired network), which transmits data, such as in the form of flows intended for communication terminals 3, 3′ capable of receiving the transmitted data.

The telecommunication network may be any type of telecommunication network that is capable of exchanging data, messages, or requests with the terminals 3, 3′.

A terminal 3, 3′ may, for example, be a land-line or mobile telephone, a desktop or portable computer, a personal digital assistant (or PDA), or videoconferencing equipment, or a device capable of receiving audio and/or video data.

The terminals 3, 3′ are further capable of establishing a communication session between themselves by means of the network 1, with this communication session enabling, for example, a meeting between participants located at sites which are generally remote.

Any data transmission mode may be considered, and particularly multi-peer (or “multicast”) mode, i.e. one making it possible to establish a communication session between participants from several sites, but also peer-to-peer (or “unicast”) mode, i.e. one making it possible to establish a communication session between participants from two sites.

Additionally, a communication session server 5, through interaction with the terminals 3, 3′, enables the implementation of a method for generating a set of user identifiers associated with terminals' 3, 3′ users' 7, 7′ introduction information transmitted during a communication session established between the terminals 3, 3′ by means of the network 1, as well as the implementation of a method enabling at least one user 7, 7′ of a terminal 3, 3′ to access user introduction information based on associated user identifiers.

In the example depicted, FIG. 1 shows three terminals 3, 3′ for accessing data, transmitted via the telecommunication network 1, which may be displayed on the display means 4, 4′ of the terminals 3, 3′.

During a communication session established between the terminals 3, the various users 7 of the terminals 3 introduce themselves, such as at the beginning of the communication session.

To that end, the terminals 3 comprise at least one processing means for transmitting the users' 7 introduction information 9 over the network 1 during their introductions.

Preferably, the terminals 3 are capable of transmitting their identification data.

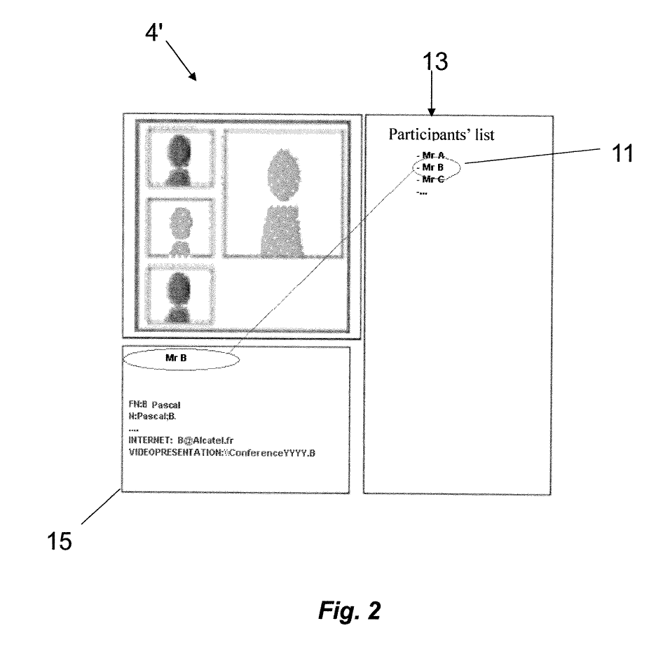

The inventive server 5 comprises at least one processing means for:
receiving this introduction information 9, and preferentially the terminals' 3 identification data;
saving the received introduction information 9, this introduction information 9 being saved, for example, in memorization means;
associating the saved introduction information 9 of a user 7 with a user identifier 11 (FIG. 2), for example the corresponding user's 7 name, here Mr. A, Mr. B, and Mr. C;
generating and sending a set 13 of various user identifiers 11 to terminals 3; this set 13 may, for example, be a list.

Once the set 13 is received by the terminals 3, the set 13 may be displayed on the display means 4, such as a screen.

In this manner, the introduction information 9 of the users 7 participating in the communication session are made available to each of a terminal's 3 users 7 from that terminal 3.

Advantageously, the server 5 is capable of detecting a terminal 3′ which joins the communication session after it has begun. If so, the server 5 automatically sends the set 13 to the detected terminal 3′.

Advantageously, the terminal 3′ comprises at least one processing means for receiving the set 13, and, for example, displaying it on the display means 4′.

In one particular embodiment, the communication session is a telephone conference.

In one preferential embodiment, the communication session is a videoconference.

To that end, the terminals 3, 3′ may, for example, be equipped with a video camera, a microphone, and speakers.

In such a case, multiple users 7, 7′ may use a terminal 3, 3′ participating in the videoconference, for example, being seated around a conference table facing a view screen 4, 4′.

This view screen 4, 4′ makes it possible to see the remote participants with a synchronization of visual data and audio data.

Preferably, the introduction information 9 is saved in the form of electronic calling cards 15 in a format enabling the exchange of personal data over the network 1.

An electronic calling card 15 may include the user's last name, at least one given name, at least one e-mail address, at least one physical address, a logo, a photo, or even an audio or video file, and may be displayed on the display means 4, 4′.

In one advantageous embodiment, the introduction information 9 includes audio data. This audio data may, for example, be transmitted in the form of an audio file from the calling card 15.

If so, the server 5 is advantageously capable of generating a query message asking the user 7′ if he wants to hear the introduction information 9.

The server 5 is preferentially capable of transmitting the query message over the network 1 to the terminal 3′ that generated the request. This transmission may, for example, be carried out during the transmission of the introduction information 9 to the terminal 3′ over the network 1.

It may also be provided that whenever the user 7′ listens to this introduction information 9, this information is only audible at the terminal 3′, so as not to disrupt the communication session that is underway.

In one preferred embodiment, the introduction information 9 includes video data.

As can be seen in FIG. 2, the electronic calling card 15 of the user Mr. B includes a video file from Mr. B's introduction represented by a link, in this case videointroduction:\\Conference YYYY.B.

In such a case, it may be provided for the query message to ask user 7′ if he wants to view the introduction video.

Advantageously, the terminal 3′ comprises at least one processing means for selecting an identifier 11 from among the set 13 whenever the user 7′ of the terminal 3′ wishes to have access to the introduction information 9 of the user 7 whose identifier 11 he has selected, for example Mr. B, as depicted in FIG. 2.

To that end, the terminal 3′ is advantageously capable of generating a request for introduction information 9 for the user 7 whose identifier 11 was selected, i.e. Mr. B.

This request comprises the selected identifier 11, and advantageously at least one piece of data identifying the terminal 3′ that generated the request.

Additionally, the terminal 3′ comprises at least one processing means for sending the request generated in relation with the selected identifier 11 to the server 5 over the network 1.

The server 5 preferably comprises at least one processing means for receiving this request and processing it.

When processing the request, the server 5 accesses the selected identifier 11 and potentially the terminal's 3′ identification data, and may search within the memorization means for the introduction information 9 associated with the identifier 11 selected by the user 7′.

The server 5 comprises at least one processing means for sending the introduction information 9 associated with the selected identifier to the terminal 3′, once the search for introduction information 9 is finished, for example.

The terminal 3′ advantageously comprises at least one processing means for receiving this introduction information 9 and delivering this introduction information 9 in a visible and/or audible form.

Naturally, the terminals 3 and 3′, as described above, have the same processing means.

In this manner, any user 7, 7′ participating in the communication session can, upon request, access the introduction information 9 of various users 7, 7′ participating in the communication session.

Naturally, the terminal 3′, in a manner similar to the terminals 3, comprises at least one processing means for transmitting the user's 7′ introduction information 9, and potentially at least one piece of identification data, over the network 1.

In such a case, the server 5 comprises at least one processing means for:
receiving this introduction information 9, and potentially receiving the terminal's 3′ identification data;
   saving the user's 7 received introduction information 9; and
associating the saved introduction information 9 with a user's identifier 11;
advantageously updating the set 13 of user identifiers 11; and
sending the updated set 13 to the terminals 3, 3′.

In such a case, the terminals 3,3′ preferentially comprise at least one processing means for receiving the updated set 13.

The server 5 may further include at least one means for managing the user identifiers 11 saved in the memorization means.

In one variant embodiment, the identifiers 11 may be automatically deleted by the server 5 once the communication session is over.

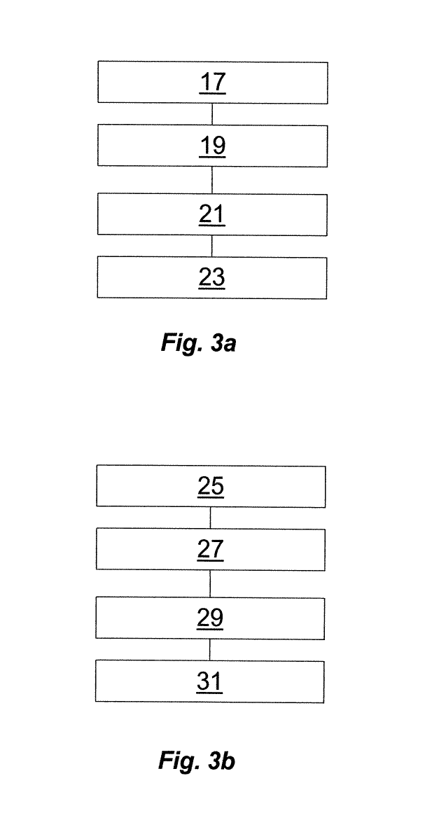

As depicted in FIG. 3a, the inventive method for generating a set 13 of user identifiers 11 comprises multiple steps, detailed below.

During a communication session established between terminals 3, 3′, the various users 7,7′ of the terminals 3,3′ introduce themselves, such as at the start of the communication session, so that the terminals 3, 3′ can transmit introduction information 9 over the network 1.

The server 5 then receives the introduction information 9, which is step 17. It may be provided that the server 5 also receives the terminals' 3, 3′ identification data.

Upon the completion of this step 17, the server 5, during a step 19, saves this introduction information 9 in memorization means, and during a step 21, respectively associates them with a user identifier 11.

The server 5 then generates a set 13 of various user identifiers 11, and sends it to the terminals 3, 3′ over the network 1; this is step 23.

Once the set 13 is received at the terminals 3, 3′, the list may be displayed on the display means 4, 4′ of the terminals 3, 3′, for example a screen.

As depicted in FIG. 3b, the inventive method for accessing user introduction information comprises multiple steps, detailed below.

A user 7, 7′, during a step 25, selects an identifier 11 from among the set 13 when he wishes to access the introduction information 9 of the user whose identifier 11 he has selected.

The terminal 3, 3′ then generates a request for that user's introduction information, and sends it to the server 5, which is step 27.

This request includes the selected identifier 11, and advantageously at least one piece of data identifying the terminal 3, 3′ that generated the request.

Upon the completion of this step 27, the server 5 receives and processes the request. When processing the request, the server 5 accesses the selected identifier 11 and potentially the data identifying the terminal 3, 3′ that generated the request.

It may be provided for the server 5 to search in the memorization means for the introduction information 9 associated with the selected identifier 11.

The server 5 then sends the introduction information 9 associated with the selected identifier 11 to the terminal 3, 3′ that generated the request.

The terminal 3, 3′ that generated the request then receives this introduction information 9 during step 29, then delivers it during step 31 in an audible and/or visible form.

The inventive method for generating a set of user identifiers associated with user introduction information and the inventive method for accessing this user introduction information are advantageously implemented by a system including at least one communication session server 5 and at least one communication terminal 3 as described above.

It is therefore understood that with such methods, a user has a simple way to access the introduction information of various users participating in a communication session, whenever he so desires, even if he joins the communication session late, whereas the introductions are generally made at the beginning of the communication session.

1. A method for generating a set (13) of user (7) identifiers (11) associated with communication terminal (3, 3′) user (7) introduction information (9) transmitted during a communication session established between said terminals (3, 3′) by means of a telecommunication network (1), comprising the following steps:
receiving user (7) introduction information (9) transmitted by at least one of said terminals (3, 3) during the communication session established between said terminals (3, 3);
recording said introduction information (9);
associating a user identifier (11) with said saved introduction information (9),
sending a set (13) of user identifiers (11) in such a way that a user (7, 7′) of a communication terminal (3, 3′) can select a user identifier (11) from among said set (13) and thereby be able to access said introduction information (9) associated with the selected user identifier (11).

2. A method according to claim 1, wherein the communication session is a telephone conference.

3. A method according to claim 1, wherein the communication session is a videoconference.

4. A method according to claim 1, wherein said information is saved in the form of electronic calling cards (15).

5. A method according to claim 1, wherein said introduction information comprises audio data.

6. A method according to claim 1, wherein said introduction information comprises video data.

7. A method enabling at least one user (7, 7′) of a communication terminal (3, 3′) to access communication terminals' (3, 3′) users' (7, 7′) introduction information (9) transmitted during a communication session established between said terminals (3, 3′) by means of a telecommunication network (1), based on associated user identifiers (11), comprising the following steps:
selecting at least one user identifier (11) from among a set (13) of user identifiers (11);
sending a request for user introduction information (9) associated with the selected user identifier (11);
receiving the user introduction information (9) associated with the selected user identifier (11); and
delivering the introduction information (9) to the user in a visible and/or audible form.

8. A session server for communication between communication terminals (3, 3′) by means of a telecommunication network (1), comprising at least one processing means for:
receiving said terminals' (3, 3′) users' (7, 7′) introduction information (9) transmitted by at least one of said terminals (3, 3′);
saving said introduction information (9);
associating a user (7, 7′) identifier (11) with said saved introduction information (9), and
sending a set (13) of user (7, 7′) identifiers (11) over said network (1).

9. A server according to claim 8, comprising at least one processing means for:
receiving a request for a user's (7, 7′) introduction information (9);
processing said request, and
transmitting said user's (7, 7′) introduction information (9) over said network (1).

10. A communication terminal capable of establishing a communication session with at least one other communication terminal (3,3′) by means of a telecommunication network (1), comprising at least one processing means for:
transmitting said terminal's user's (7, 7′) introduction information (9) over said network (1); and
receiving a set (13) of users' (7, 7′) identifiers (11), respectively associated with said terminals' (3, 3′) users' (7, 7′) introduction information (9).

11. A terminal according to claim 10, comprising at least one processing means for:
selecting a user (7, 7′) identifier (11) from among said set (13),
sending a request for said user's (7, 7′) introduction information (9);
receiving said introduction information (9) associated with the selected user's (7, 7′) identifier (11), and
delivering the received introduction information (9) in a visible and/or audible form.
